(19) United States
(12) Patent Application Publication
(10) Pub. No.: US 2026/0281722 A1
(43) Pub. Date: Sep. 17, 2026

(54) A METHOD OF HOME NETWORK TRIGGERED PRIMARY AUTHENTICATION FOR AKMA KEY REFRESH

(71) Applicant: ZTE CORPORATION, Shenzhen (CN)

(72) Inventors: Peilin LIU, Shenzhen (CN); Shilin YOU, Shenzhen (CN); Yuze LIU, Shenzhen (CN); Wei MA, Shenzhen (CN)

(73) Assignee: ZTE CORPORATION, Shenzhen (CN)

(21) Appl. No.: 19/480,284

(22) PCT Filed: May 15, 2023
(86) PCT No.: PCT/CN2023/094106

§ 371 Date: Oct. 30, 2025

(51) Int. Cl. H04W 12/06; H04W 12/04

(52) U.S. Cl. CPC H04W 12/06; H04W 12/04

(57) ABSTRACT

The present disclosure describes techniques for refreshing an authentication key by triggering primary authentication in a wireless communication system. An Application Function (AF) subscribes to a Policy Control Function (PCF) to receive a notification of a User Equipment (UE) access type. The AF receives the notification of the access type from the PCF. The AF receives an application session establishment request from the UE. The AF transmits the access type to an Authentication and Key Management for Applications Anchor Function (AAnF). The AF receives a new authentication key from the AAnF. The AF transmits an application session establishment response to the UE. The AF receives a new authentication key from the AAnF with an associated timer expiration time.

### TECHNICAL FIELD

The present subject matter is directed generally to wireless communications. Particularly, the present subject matter relates to methods, devices, and systems to enable refresh of an Authentication and Key Management for Applications (AKMA) key by triggering primary authentication from a home network.

### BACKGROUND

In 3GPP Technical Specification (TS) 33.535, the AKMA Application Key (K_{AF}) may only be refreshed by the Ua* protocol; no other method exists to refresh the K_{AF}. If the Ua* protocol does not support K_{AF} key refresh, and the AKMA Anchor Key (K_{AKMA}) is unchanged, the same K_{AF} key will be generated again. On the other hand, this issue may be solvable if the K_{AKMA} key can be refreshed.

The AKMA features specified in TS 33.535 do not support refresh of the K_{AKMA}. In fact, refresh of the AKMA keys is not possible during the lifetime of the K_{AUSF} key even when the lifetime of the K_{AF} key has expired. In accordance with the present subject matter, by triggering the primary authentication from a home network, the AUthentication Server Function (AUSF) may generate a new K_{AUSF} key and a new K_{AKMA} key. Further, the present subject matter may provide techniques to select the Access and Mobility Management Function (AMF) to trigger the primary authentication.

### SUMMARY

The present subject matter is directed to a method, device, and system for refreshing an AKMA key by triggering primary authentication from a home network.

In some embodiments, a method for refreshing an authentication key by triggering primary authentication in a wireless communication system includes transmitting an application session establishment request to an Application Function (AF); and receiving an application session establishment response from the AF. The application session establishment response comprises an indication that no Authentication and Key Management for Applications (AKMA) subscription for a User Equipment (UE) exists in a Unified Data Management (UDM). The method further includes refraining from initiating further application session establishment requests based on the indication.

In some embodiments, a method for refreshing an authentication key by triggering primary authentication in a wireless communication system includes subscribing, by an Application Function (AF), to a Policy Control Function (PCF) to receive a notification of a User Equipment (UE) access type; receiving the notification of the access type from the PCF; receiving an application session establishment request from the UE; transmitting the access type to an Authentication and Key Management for Applications Anchor Function (AAnF); receiving a new authentication key from the AAnF; and transmitting an application session establishment response to the UE.

In some embodiments, a method for refreshing an authentication key by triggering primary authentication in a wireless communication system, includes receiving, by a Unified Data Management (UDM), an authentication request from an Anchor Function (AAnF) that includes a User Equipment (UE) access type; checking whether an Authentication and Key Management for Applications (AKMA) subscription of the UE exists; and transmitting an authentication response to the AAnF comprising a success or failure result.

In some embodiments, a method for refreshing an authentication key by triggering primary authentication in a wireless communication system, includes receiving, by an Anchor Function (AAnF), a request for a new authentication key for a User Equipment (UE) from an Application Function (AF). The request includes a UE access type. The method further includes forwarding the access type to a Unified Data Management (UDM).

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example wireless communication system including a wireless base station and user equipment.

FIG. 2 shows an example of a base station.

FIG. 3 shows an example of user equipment.

FIG. 4 shows a swim lane diagram of an example home network triggered primary authentication communication.

FIG. 5 shows a swim lane diagram of an example home network triggered primary authentication communication.

FIG. 6 shows a swim lane diagram of an example home network triggered primary authentication communication.

### DETAILED DESCRIPTION

The present subject matter will now be described in detail hereinafter with reference to the accompanied drawings, which form a part of the present subject matter, and which show, by way of illustration, specific examples of embodiments. Please note that the present subject matter may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures, or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

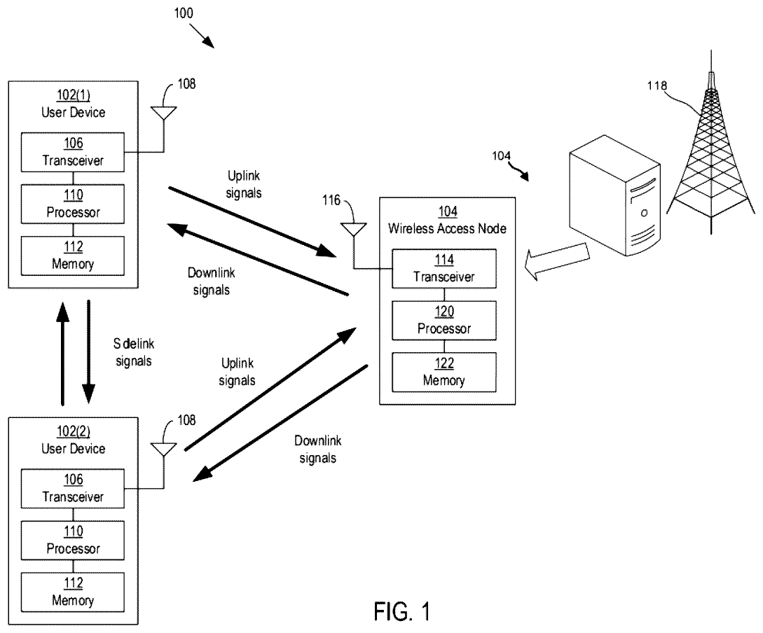

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless communication system 100—such as a user device 102 and a wireless access node 104, two user devices 102 without a wireless access node 104, or two wireless access nodes 104 without a user device 102 may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition, or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless communication system 100, the communication nodes are configured to wirelessly communicate signals between each other. In general, a communication in the wireless communication system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless communication system 100 can both send and receive signals, a single communication node may be both a transmitting/source node and a receiving/destination node simultaneously or switch between being a source/transmitting node and a destination/receiving node.

Also, particular signals may be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the wireless communication system 100 may be characterized or defined as a data signal or a control signal. In general, a data signal is a signal that includes or carries data, such multimedia data (e.g., voice and/or image data), and a control signal is a signal that carries control information that configures the communication nodes in certain ways to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, in the wireless communication system 100, a slot format for a plurality of slots or frames may be configured by the wireless access node 104 or specified by a protocol. In some examples, a slot may be indicated or specified as a downlink slot, a flexible slot, or an uplink slot. Also, an orthogonal frequency divisional multiplexing (OFDM) symbol may be indicated or specified as a downlink symbol, a flexible symbol, or an uplink symbol, in various embodiments.

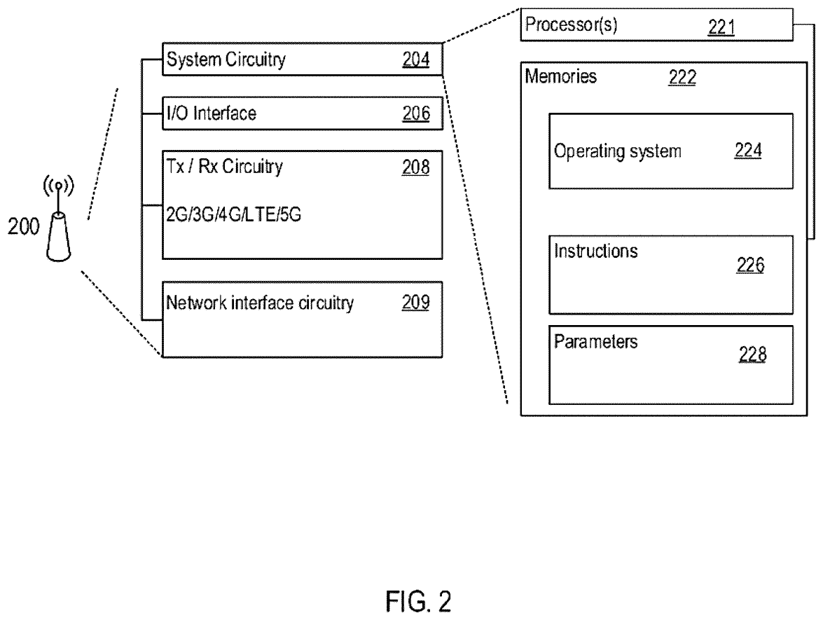

FIG. 2 shows an example of base station 200. The example base station 200 may include radio transmitting/receiving (Tx/Rx) circuitry 208 to transmit/receive communication with UEs and/or other base stations. The base station 200 may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

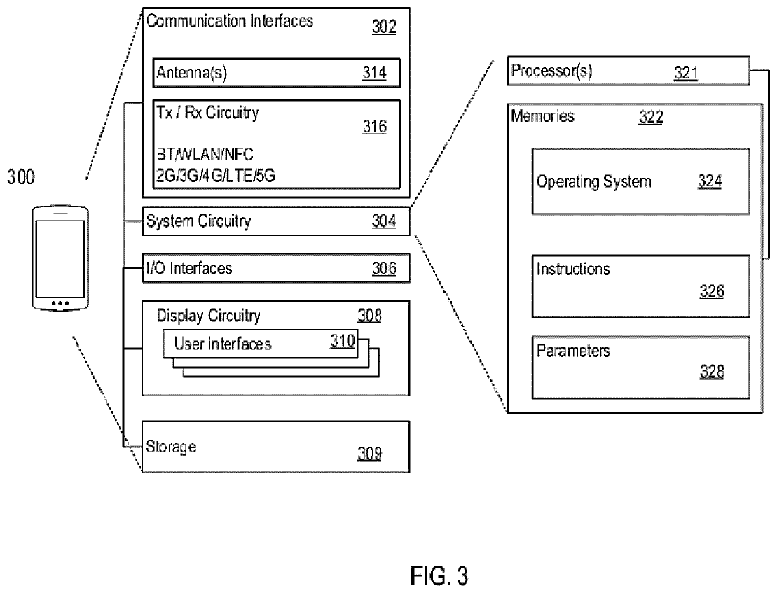

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers, and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

The system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

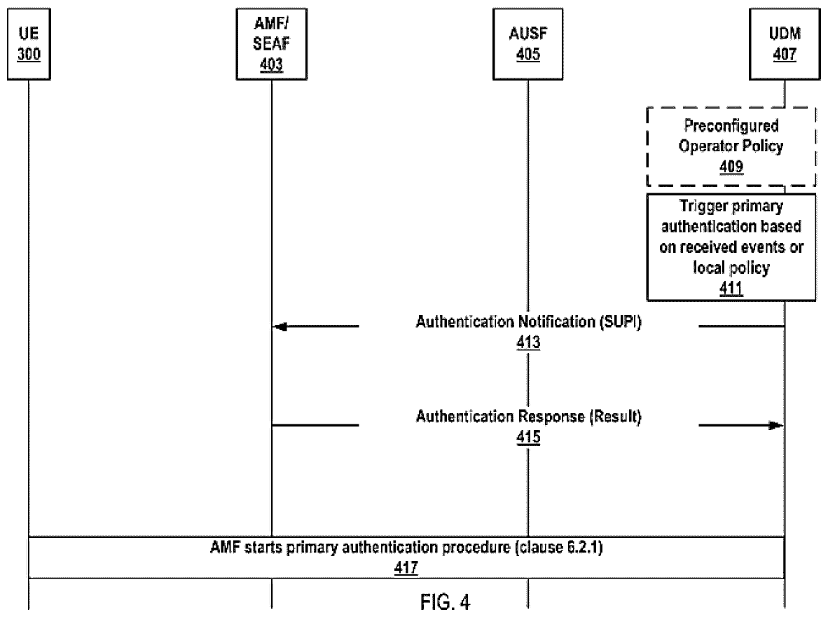

FIG. 4 shows a swim lane diagram of an example home network triggered primary authentication communication between several entities. The entities shown in FIG. 4 include the UE 300, Access and Mobility Management Function/Security Anchor Function (AMF/SEAF) 403, Authentication Server Function (AUSF) 405, and Unified Data Management (UDM) 407. The UDM 407, AUSF 405, and AMF/SEAF 403 are network functions in the control plane function group of the 5G system architecture. The UDM 407 may initiate primary authentication based on procedures initiated by the UE 300 (e.g., UE registration in 5GC), towards the UE 300 (e.g., Steering of Roaming (SoR)/Update Parameter Update (UPU)), or other events from other Network Functions (NFs), considering the local policy as well. Alternatively, or in addition, the UDM 407 may be preconfigured with an operator authentication policy 409 to determine when to trigger a primary authentication procedure 411. The UE 300 may register to the network. As part of the registration, the serving AMF/SEAF 403 may register the UE 300 with the UDM 407 via the Nudm_UECM_Registration per TS 23.502, clause 4.2.2.2.2. The UDM 407 may create an implicit subscription for the serving AMF/SEAF 403 for the UDM 407 to later notify the AMF/SEAF 403 for potential re-authentication.

A prerequisite for initiating the home network triggered policy authentication may be that the UDM 407 already has the information about the AMF/SEAF 403 serving the UE 300. Otherwise, the UDM 407 may be unable to contact any AMF/SEAF 403 in subsequent steps.

The UDM 407 may decide independently based on events (e.g., SoR/UPU or if the AKMA Anchor Function (AAnF) requests) or authentication policy, and may trigger home network primary authentication 411 as will be subsequently described. The AAnF may determine, based on certain factors, to request the UDM 407 for primary authentication using the UDM services described in clause 14 of TS 33.501.

Based on a received event and the local operator authentication policy, when there is no ongoing primary authentication for the UE 300 and if the UDM 407 determines to trigger primary authentication 411, the UDM 407 may determine the serving AMF/SEAF 403 of the target UE 300.

If there are different AMFs/SEAFs 403 registered in the UDM 407 for different access, and the procedure defined in proposed clause 6.1X of TS 33.501 is supported, the UDM 407 may select one AMF/SEAF 403 to perform the reauthentication.

The UDM 407 may send a notification 413 to the AMF/SEAF 403 with the UE's 300 Subscription Permanent Identifier (SUPI). After receiving the notification 413 from the UDM 407, the AMF/SEAF 403 may decide whether to execute the primary authentication procedure based on its own local authentication policy and the UE 300 state. For instance, if the UE 300 is under handover, or when the UE 300 is already under authentication by the AMF/SEAF 403 before receiving the authentication notification 413 from the UDM 407, a similar procedure as in a Network Triggered Service Request (i.e., TS 23.502, clause 4.2.3.3) may be reused. If the AMF/SEAF 403 cannot execute a primary authentication, the AMF/SEAF 403 may send the authentication response message 415 to the UDM 407 with an acknowledgement that includes a failure result; else, the result may be set as a success.

In the case where a failure is received in the authentication response message 415 from the AMF/SEAF 403, the UDM 407 may check if another AMF/SEAF 403 is available and able to accessed in another manner. If available, the UDM 407 may select another AMF/SEAF 403 and send an authentication notification 413. The AMF/SEAF 403 may then begin the primary authentication procedure 417 as defined in clause 6.2.1 of TS 33.501.

The UDM 407 may execute other procedures (e.g., SoR/UPU) depending on the result that caused the UDM 407 to trigger the authentication (or re-authentication) step 411.

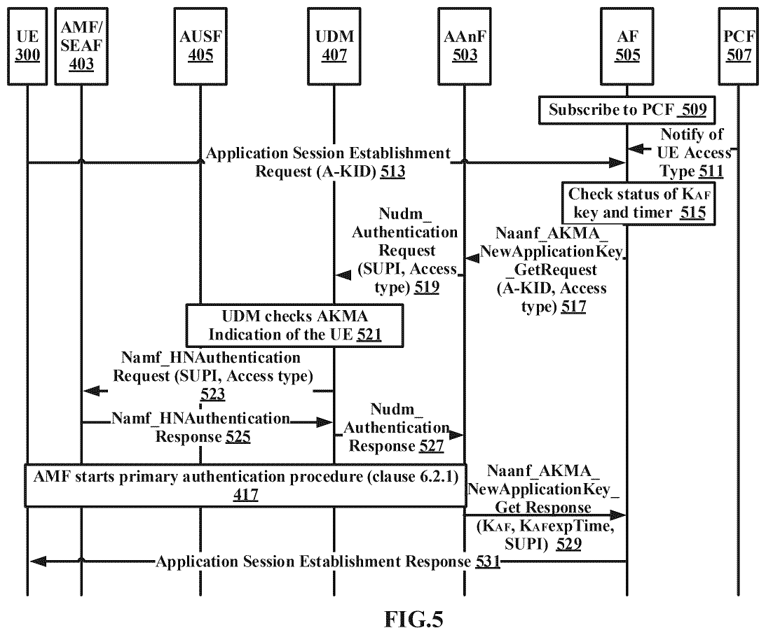

FIG. 5 shows a swim lane diagram of an example home network triggered primary authentication communication between several entities in a case where the K_{AF} key may be invalid. Specifically, FIG. 5 additionally illustrates the AAnF 503, the Application Function (AF) 505, and the Policy Control Function (PCF) 507 elements. Like the UDM 407, AUSF 405, and AMF/SEAF 403, the AF 505 is a network functions in the control plane function group of the 5G system architecture

The AF 505 may subscribe 509 to the PCF 507 to be notified of the Access Type that the UE 300 may be currently using and the access type change. The Access Type may be 3GPP or non-3GPP.

The PCF 507 may forward the Access Type in a notification 511 to the AF 505. The AF 505 may store the Access Type.

When the UE 300 initiates communication with the AKMA AF 505, the UE 300 may send an Application Session Establishment Request message 513 to the AF 505, which may include a derived AKMA Key Identifier (A-KID). If the UE 300 Access Type associated with the Application Session Establishment Request message 513 has changed when compared with previous sessions, the UE 300 may be notified of the current Access Type by the PCF 507 by forwarding the Access Type as described with reference to notification 511.

After receiving the Application Session Establishment Request Message 513, the AF 505 may check the status 515 of the K_{AF} key. If the K_{AF} timer has expired or if the AF 505 determines the current K_{AF} key is not secure, the AF 505 may request a new K_{AF} key.

The AF 505 may select the AAnF 503 according to the Routing InDicator (RID) in the A-KID and may send a Naanf_AKMA_NewApplicationKey_Get request 517 to the AAnF 503 with the A-KID to request a new K_{AF} key for the UE 300. The AF 505 may also include its identity (AF_ID) and the current Access Type in the request 517.

After receiving the request 517, the AAnF 503 may check the AKMA context of the UE 300 according to the A-KID. If the checking reveals that the AKMA context of the UE 300 exists, the AAnF 503 may then send a Nudm_Authentication Request 519 to the UDM 407, which may include the SUPI of the UE 300 and the Access Type. If no AKMA context of the UE 300 exists, the AAnF 503 may request the UE ID from the AF 505 before sending the Nudm_Authentication Request message 519.

The UDM 407 may check if valid AKMA context and an AKMA subscription of the UE 300 exists in step 521. If there is no AKMA subscription corresponding to the UE 300, subsequent steps 523, 525, and 417 may be skipped, and the UDM 407 may send an authentication response 527 to the AAnF 503 as shown with an acknowledgement that includes a failure result specifying a cause to be no AKMA subscription.

If the UDM 407 checks for valid AKMA context and an AKMA subscription of the UE 300 in 521 and a subscription does exist, the UDM 407 may select an AMF/SEAF 403 based on the current Access Type associated with the Application Session Establishment Request message 513 and received in request 519, and send a home network triggered authentication request (i.e., Namf_HNAuthentication Request) 523 to the selected AMF/SEAF 403 according to the current Access Type associated with the Application Session Establishment Request message 513. The UDM 407 may also include the SUPI of the UE 300 and Access Type in the Request 523.

After receiving the Request 523 from the UDM 407, the AMF/SEAF 403 may decide whether to execute the primary authentication procedure based on its own local authentication policy, and the UE 300 state. If the AMF/SEAF 403 cannot execute the primary authentication, step 417 may be skipped, and the AMF/SEAF 403 may send the authentication response message (i.e., Namf_HNAuthentication Response) 525 to the UDM 407 with an acknowledgement that includes a failure result; else, the result may be set as a success.

The UDM 407 may send an authentication response (i.e., Nudm_Authentication Response) 527 to the AAnF 503, which may include the received authentication results that were included with the authentication response message 525.

The AMF/SEAF 403 may then begin the primary authentication procedure 417 in accordance with clause 6.2.1 of TS 33.501.

If the primary authentication 417 is successfully performed, the AAnF 503 may send a Naanf_AKMA_NewApplicationKey_Get response 529 to the AF 505 with the SUPI or Generic Public Subscription Identifier (GPSI), a new K_{AF} key, and the K_{AF} expiration time. Whether to send the SUPI or GPSI may be determined by the AAnF 503 based on the local policy. If the AAnF 503 receives a failure result in 527, the AAnF 503 may include the cause of the failure in the NaaNF_AKMA_NewApplicationKey_Get response 529.

The AF 505 may send the Application Session Establishment Response 531 to the UE 300. If the information in the response 529 indicates a failure result of the AKMA key request, the AF 505 may reject the Application Session Establishment Request 513 by including the failure cause in the Application Session Establishment Response 531. If the failure cause indicates that there is no AKMA subscription of the UE 300 in the UDM 407, the UE 300 may not initiate (i.e., refrains from transmitting) further Application Session Establishment Request(s) 513 to the AF 505.

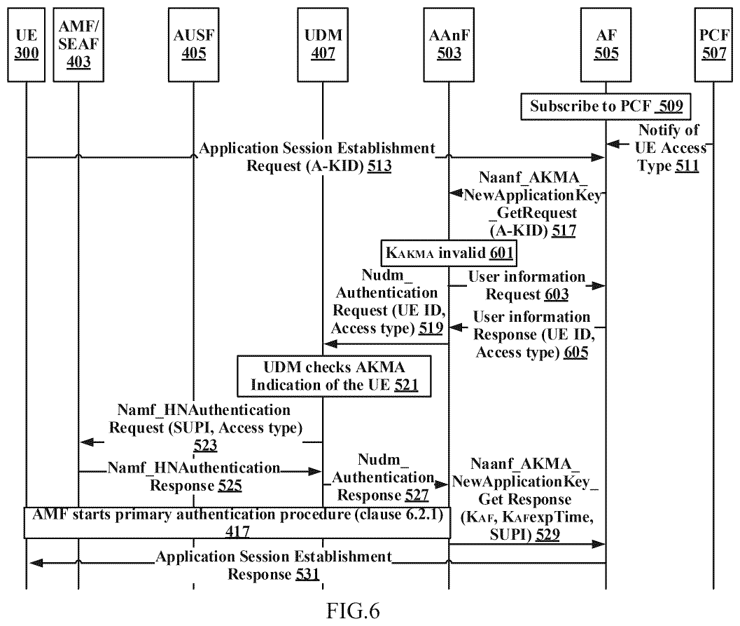

FIG. 6 shows a swim lane diagram of an example home network triggered primary authentication communication between several entities in a case where the K_{AKMA} key may be invalid.

The AF 505 may subscribe 509 to the PCF 507 to be notified of the Access Type that the UE 300 may be currently using and the access type change. The Access Type may be 3GPP or non-3GPP.

The PCF 507 may forward the Access Type in a notification 511 to the AF 505. The AF 505 may store the Access Type.

When the UE 300 initiates communication with the AKMA AF 505, the UE 300 may send an Application Session Establishment Request message 513 to the AF 505, which may include a derived AKMA Key IDentifier (A-KID). If the UE 300 Access Type associated with the Application Session Establishment Request message 513 has changed when compared with previous sessions, the UE 300 may be notified of the current Access Type by the PCF 507 by forwarding the Access Type as described with reference to notification 511.

The AF 505 may select the AAnF 503 according to the RID in the A-KID and may send a Naanf_AKMA_NewApplicationKey_Get request 517 to the AAnF 503 with the A-KID to request a new K_{AF} key for the UE 300. The AF 505 may also include its identity (AF_ID) and the current Access Type in the request 517.

After receiving the request 517, the AAnF 503 may check the AKMA context of the UE 300 according to the A-KID to determine if the K_{AKMA} key is invalid 601. If AKMA context of the UE 300 is expired (e.g., the associated authentication key timer has expired), subsequent steps 603 and 605 may be skipped.

If there is no AKMA context of the UE 300 (i.e., the K_{AKMA} key is invalid), the AAnF 503 may send a user information request 603 to the AF 505.

The AF may transmit a user information response 605 to the user information request 603 back to the AAnF 503, which may include the UE ID and the current Access Type. The UE ID may be a SUPI or a GPSI.

The AAnF 503 may then send a Nudm_Authentication Request message 519 to the UDM 407, which may include the UE ID of the UE 300 and the Access Type.

The UDM 407 may check if valid AKMA context and an AKMA subscription of the UE 300 exists in step 521. If there is no AKMA subscription corresponding to the UE 300, subsequent steps 523, 525, and 417 may be skipped, and the UDM 407 may send an authentication response 527 to the AAnF 503 as shown with an acknowledgement that includes a failure result specifying a cause to be no AKMA subscription.

If the UDM 407 checks for valid AKMA context and an AKMA subscription of the UE 300 in 521 and a subscription does exist, the UDM 407 may select an AMF/SEAF 403 based on the current Access Type associated with the Application Session Establishment Request message 513 and received in request 519, and send a home network triggered authentication request (i.e., NAmf_HNAuthentication Request) 523 to the selected AMF/SEAF 403 according to the current Access Type associated with the Application Session Establishment Request message 513. The UDM 407 may also include the SUPI of the UE 300 and Access Type in the Request 523.

After receiving the Request 523 from the UDM 407, the AMF/SEAF 403 may decide whether to execute the primary authentication procedure based on its own local authentication policy, and the UE 300 state. If the AMF/SEAF 403 cannot execute the primary authentication, step 417 may be skipped, and the AMF/SEAF 403 may send the authentication response message (i.e., Namf_HNAuthentication Response) 525 to the UDM 407 with an acknowledgement that includes a failure result; else, the result may be set as a success.

The UDM 407 may send an authentication response (i.e., Nudm_Authentication Response) 527 to the AAnF 503, which may include the received authentication results that were included with the authentication response message 525.

The AMF/SEAF 403 may then begin the primary authentication procedure 417 in accordance with clause 6.2.1 of TS 33.501.

If the primary authentication 417 is successfully performed, the AAnF 503 may send a Naanf_AKMA_NewApplicationKey_Get response 529 to the AF 505 with the SUPI or Generic Public Subscription Identifier (GPSI), a new K_{AF} key, and the K_{AF} expiration time. Whether to send the SUPI or GPSI may be determined by the AAnF 503 based on the local policy. If the AAnF 503 receives a failure result in 527, the AAnF 503 may include the cause of the failure in the NaaNF_AKMA_NewApplicationKey_Get response 529.

The AF 505 may send the Application Session Establishment Response 531 to the UE 300. If the information in the response 529 indicates a failure result of the AKMA key request, the AF 505 may reject the Application Session Establishment Request 513 by including the failure cause in the Application Session Establishment Response 531. If the failure cause indicates that there is no AKMA subscription of the UE 300 in the UDM 407, the UE 300 may not initiate (i.e., refrains from transmitting) further Application Session Establishment Request(s) 513 to the AF 505.

In sum, the present subject matter describes a technique to enable home network-triggered primary authentication to refresh an AKMA key in the case where the K_{AF} key is invalid and/or where the K_{AKMA} key is invalid. When multiple access types are associated with the UE 300, the access type information may be considered in determining the AMF/SEAF 403 to trigger the primary authentication 417. If the UE 300 receives a failure cause indicating no AKMA subscription exists in the UDM 407, the UE 300 may not initiate the Application Session Establishment Request 513 to the AF 505 any longer.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for refreshing an authentication key by triggering primary authentication in a wireless communication system, comprising: transmitting an application session establishment request to an Application Function (AF); receiving an application session establishment response from the AF, wherein the application session establishment response comprises an indication that no Authentication and Key Management for Applications (AKMA) subscription for a User Equipment (UE) exists in a Unified Data Management (UDM); and refraining from initiating further application session establishment requests based on the indication.

A second aspect includes a method for refreshing an authentication key by triggering primary authentication in a wireless communication system, comprising: subscribing, by an Application Function (AF), to a Policy Control Function (PCF) to receive a notification of a User Equipment (UE) access type; receiving the notification of the access type from the PCF; receiving an application session establishment request from the UE; transmitting the access type to an Authentication and Key Management for Applications Anchor Function (AAnF); receiving a new authentication key from the AAnF; and transmitting an application session establishment response to the UE.

A third aspect includes the method of any preceding aspect, further comprising: determining that a timer of the authentication key has expired, wherein the access type is transmitted in a request for the new authentication key based on the expired timer.

A fourth aspect includes the method of any preceding aspect, wherein the request for the new authentication key further includes an Authentication and Key Management for Applications (AKMA) key identifier (A-KID).

A fifth aspect includes the method of any preceding aspect, wherein the request for the new authentication key further includes an identifier of the AF.

A sixth aspect includes the method of any preceding aspect, wherein the new authentication key is received from the AAnF with an associated timer expiration time.

A seventh aspect includes the method of any preceding aspect, wherein the new authentication key is received from the AAnF with a Subscription Permanent Identifier (SUPI) or Generic Public Subscription Identifier (GPSI) of the UE.

An eighth aspect includes the method of any preceding aspect, further comprising: receiving a user information request from the AAnF.

A ninth aspect includes the method of any preceding aspect, further comprising: transmitting a user information response to the AAnF comprising an ID and access type of the UE.

A tenth aspect includes a method for refreshing an authentication key by triggering primary authentication in a wireless communication system, comprising: receiving, by a Unified Data Management (UDM), an authentication request from an Anchor Function (AAnF) that includes a User Equipment (UE) access type; checking whether an Authentication and Key Management for Applications (AKMA) subscription of the UE exists; and transmitting an authentication response to the AAnF comprising a success or failure result.

An eleventh aspect includes the method of any preceding aspect, wherein the authentication response comprises a success result, and the method further comprises: selecting, based on the UE access type and the existence of the AKMA subscription, an Access and Mobility Management Function/Security Anchor Function (AMF/SEAF) to begin the primary authentication using the authentication key between the UE and an Application Function (AF).

A twelfth aspect includes the method of any preceding aspect, further comprising: transmitting a home network triggered authentication request to the selected AMF/SEAF, wherein the home network triggered authentication request comprises a Subscription Permanent Identifier (SUPI) and/or the access type of the UE.

A thirteenth aspect includes the method of any preceding aspect, further comprising: receiving a home network triggered authentication response from the selected AMF/SEAF, wherein the home network triggered authentication response comprises a success or failure result.

A fourteenth aspect includes the method of any preceding aspect, wherein the authentication response comprises a failure result an indication of no AKMA subscription.

A fifteenth aspect includes the method of any preceding aspect, further comprising: refraining from transmitting a home network triggered authentication request to an Access and Mobility Management Function/Security Anchor Function (AMF/SEAF).

A sixteenth aspect includes the method of any preceding aspect, wherein the authentication response is a Nudm_Authentication response.

A seventeenth aspect includes the method of any preceding aspect, wherein the authentication request is a Nudm_Authentication request.

An eighteenth aspect includes the method of any preceding aspect, wherein the authentication request further includes a subscription permanent identifier (SUPI) of the UE. A nineteenth aspect includes the method of any preceding aspect, further comprising: checking whether a valid AKMA context of the UE exists.

A twentieth aspect includes the method of any preceding aspect, wherein the home network triggered authentication request is a Namf_HNAuthentication request.

A twenty-first aspect includes the method of any preceding aspect, wherein the home network triggered authentication response is a Namf_HNAuthentication response.

A twenty-second aspect includes a method for refreshing an authentication key by triggering primary authentication in a wireless communication system, comprising: receiving, by an Anchor Function (AAnF), a request for a new authentication key for a User Equipment (UE) from an Application Function (AF), wherein the request includes a UE access type; and forwarding the access type to a Unified Data Management (UDM).

A twenty-third aspect includes the method of any preceding aspect, wherein the request for the new authentication key further includes an Authentication and Key Management for Applications (AKMA) key identifier (A-KID), and the method further comprises: checking an AKMA context of the UE based on the A-KID.

A twenty-fourth aspect includes the method of any preceding aspect, wherein the access type is forwarded in an authentication request that further includes a Subscription Permanent Identifier (SUPI) of the UE.

A twenty-fifth aspect includes the method of any preceding aspect, wherein the access type is forwarded in response to the checking revealing that the AKMA context of the UE exists.

A twenty-sixth aspect includes the method of any preceding aspect, further comprising: transmitting a UE ID request to the AF before the forwarding of the access type to the UDM in response to the checking revealing that the AKMA context of the UE does not exist.

A twenty-seventh aspect includes the method of any preceding aspect, further comprising: refraining from transmitting a UE ID request to the AF before the forwarding of the access type to the UDM in response to the checking revealing that the AKMA context of the UE is expired.

A twenty-eighth aspect includes the method of any preceding aspect, wherein the request for the new authentication key further includes an Authentication and Key Management for Applications (AKMA) key identifier (A-KID), and the method further comprises: checking the AKMA context of the UE based on the A-KID to determine if the authentication key is invalid.

A twenty-ninth aspect includes the method of any preceding aspect, further comprising: transmitting a user information request to the AF in response to determining the authentication key is invalid.

A thirtieth aspect includes the method of any preceding aspect, further comprising: receiving a user information response from the AF, wherein the user information response includes a UE ID and/or the access type.

A thirty-first aspect includes the method of any preceding aspect, wherein the authentication key is an AKMA application key.

A thirty-second aspect includes the method of any preceding aspect, wherein the authentication key is an AKMA anchor key.

A thirty-third aspect includes the method of any preceding aspect, wherein the UDM is preconfigured with an operator authentication policy to determine when to trigger the primary authentication.

A thirty-fourth aspect includes the method of any preceding aspect, wherein the access type is 3GPP or non-3GPP.

A thirty-fifth aspect includes a device for wireless communication comprising: a processor; and a memory in communication with the processor, the memory storing a plurality of instructions executable by the processor to configure the device to: implement the method of any preceding aspect.

A thirty-sixth aspect includes a non-transitory computer-readable medium comprising instructions operable, when executed by one or more processors, to: implement the method of any preceding aspect.

1. (canceled)

2. A method for refreshing an authentication key by triggering primary authentication in a wireless communication system, comprising:
subscribing, by an Application Function (AF), to a Policy Control Function (PCF) to receive a notification of a User Equipment (UE) access type;
receiving the notification of the access type from the PCF;
receiving an application session establishment request from the UE;
transmitting the access type to an Authentication and Key Management for Applications Anchor Function (AAnF);
receiving a new authentication key from the AAnF; and
transmitting an application session establishment response to the UE.

3. The method of claim 2, further comprising:
determining that a timer associated with the authentication key has expired, wherein
the access type is transmitted in a request for the new authentication key based on the expired timer.

4. The method of claim 3, wherein
the request for the new authentication key further comprises an Authentication and Key Management for Applications (AKMA) key identifier (A-KID); or
the request for the new authentication key further comprises an identifier of the AF.

5. (canceled)

6. The method of claim 3, wherein
the new authentication key is received from the AAnF with an associated timer expiration time; or
the new authentication key is received from the AAnF with a Subscription Permanent Identifier (SUPI) or a Generic Public Subscription Identifier (GPSI) of the UE.

7. (canceled)

8. The method of claim 2, further comprising:
receiving a user information request from the AAnF, and
transmitting a user information response to the AAnF, wherein the user information response comprises an identifier (ID) and the access type of the UE.

9. (canceled)

10. A method for refreshing an authentication key by triggering primary authentication in a wireless communication system, comprising:
receiving, by a Unified Data Management (UDM), an authentication request from an Anchor Function (AAnF) that comprises a User Equipment (UE) access type;
checking whether an Authentication and Key Management for Applications (AKMA) subscription of the UE exists; and
transmitting an authentication response to the AAnF, wherein the authentication response comprises a success result or a failure result.

11. The method of claim 10, wherein
the authentication response comprises a success result, and
the method further comprises:
selecting, based on the UE access type and the existence of the AKMA subscription, an Access and Mobility Management Function/Security Anchor Function (AMF/SEAF) to begin the primary authentication between the UE and an Application Function (AF).

12. The method of claim 11, further comprising:
transmitting a home network triggered authentication request to the selected AMF/SEAF, wherein
the home network triggered authentication request comprises at least one of: a Subscription Permanent Identifier (SUPI) or the access type of the UE.

13. The method of claim 11, further comprising:
receiving a home network triggered authentication response from the selected AMF/SEAF, wherein
the home network triggered authentication response comprises a success result or a failure result.

14. The method of claim 10, wherein
the authentication response comprises a failure result, wherein the failure result comprises an indication of no AKMA subscription.

15-17. (canceled)

18. The method of claim 10, wherein
the authentication request further includes a subscription permanent identifier (SUPI) of the UE.

19-21. (canceled)

22. A method for refreshing an authentication key by triggering primary authentication in a wireless communication system, comprising:
receiving, by an Authentication and Key Management for Applications Anchor Function (AAnF), a request for a new authentication key for a User Equipment (UE) from an Application Function (AF), wherein
the request comprises a UE access type; and
forwarding the access type to a Unified Data Management (UDM).

23. The method of claim 22, wherein
the request for the new authentication key further comprises an Authentication and Key Management for Applications (AKMA) key identifier (A-KID), and
the method further comprises:
checking an AKMA context of the UE based on the A-KID.

24. The method of claim 23, wherein
the access type is forwarded in an authentication request that comprises a Subscription Permanent Identifier (SUPI) of the UE.

25. The method of claim 23, wherein
the access type is forwarded in response to the checking revealing that the AKMA context of the UE exists; or
the method further comprises: transmitting a UE identifier (ID) request to the AF before the forwarding of the access type to the UDM in response to the checking revealing that the AKMA context of the UE does not exist.

26-30. (canceled)

31. The method of claim 2, wherein
the authentication key is an AKMA application key; or
the authentication key is an AKMA anchor key.

32. (canceled)

33. The method of claim 10, wherein
the UDM is preconfigured with an operator authentication policy to determine when to trigger the primary authentication.

34. The method of claim 2, wherein
the access type is 3rd Generation Partnership Project (3GPP) or non-3GPP.

35. A device for wireless communication comprising:
a processor; and
a memory in communication with the processor, the memory storing a plurality of instructions executable by the processor to configure the device to:
implement the method of claim 2.

36. A non-transitory computer-readable medium comprising instructions operable, when executed by one or more processors, to:
implement the method of claim 2
